(19) United States
(12) Patent Application Publication
(10) Pub. No.: US 2026/0303391 A1
(43) Pub. Date: Oct. 1, 2026

(54) SYSTEM AND METHOD FOR MANAGING VIRTUAL CONFERENCE ROOM OF A VIRTUAL MEETING

(71) Applicant: RingCentral, Inc., Belmont, CA (US)

(72) Inventor: Martin Arastafar, Redwood City, CA (US)

(21) Appl. No.: 19/093,058

(22) Filed: Mar. 27, 2025

(51) Int. Cl. H04L 12/18

(52) U.S. Cl. CPC H04L 12/1822; H04L 12/1818

(57) ABSTRACT

A method includes recognizing that a current one-on-one session between a host and a first user has not yet ended. Upon recognizing that the current one-on-one session between the host and the first user has not yet ended, a second user is placed in a temporary virtual conference room. The method includes providing the second user with an estimated time for when the current one-on-one session will terminate based on attributes of a conversation between the host and the first user. The host is notified the current session is in overtime. The second user is notified when it is their turn to join the one-on-one session. The temporary virtual conference is dynamically terminated and the second user is moved to the one-on-one session once the first user has left.

### BACKGROUND

Recent advancements in online technology and an increase in remote work have increased the usage of collaborative conferencing platforms. Platforms such as Zoom®, Microsoft Teams®, RingCentral®, or Webex® may be used to facilitate online meetings for the purposes of business, education, recreation, etc. Many online conferences are in the form of one-on-one meetings between the host and the current participant, such as parent-teacher conferences, speed dating, or supervisor-employee meetings. In these scenarios, once the current meeting ends, the next queued participant, such as a parent, employee, or speed dater, is intended to join.

Hosts in this scenario typically send a single link to all participants, with directions to join the conference at the scheduled time. A problem associated with such queued participants using a single video conference link is that sometimes the current participant exceeds the allotted time with the host, and if the subsequent participant enters the conference room at her scheduled start time, the current participant's meeting is still ongoing. When the subsequent participant joins the meeting, the subsequent participant interrupts the meeting between the host and the current participant. This interruption can cause awkwardness, embarrassment, confusion, and uncertainty for all attendees. The subsequent participant has to abruptly drop out, not knowing when to rejoin unless contacted by the host that the former meeting is now over. The subsequent participant may rejoin randomly not knowing when is an appropriate time, and may interrupt again, or cause the host to unnecessarily wait for the new participant. Moreover, the interruption of the meeting between the current participant and host can also lead to inefficiency and lost productivity, as they will have to pause to figure out when to tell the subsequent participant to enter, and to jump back into the point of their meeting at which they were interrupted.

### SUMMARY

Accordingly, a need has arisen to manage online collaborative meetings with minimal interruptions by allowing participants to join at the appropriate time.

In some embodiments a computer-implemented method for managing queued participants in a one-on-one virtual conference is provided. The method includes recognizing that a current one-on-one session between a host and a first user has not yet ended. The method may further comprise, upon recognizing that the current one-on-one session between the host and the first user has not yet ended, placing a second user in a temporary virtual conference room. In one nonlimiting example, the method includes providing the second user with an estimated time for when the current one-on-one session will terminate based on attributes of a conversation between the host and the first user. It is appreciated that the method further includes notifying the host that the current session is in overtime. The method also includes notifying the second user when it is their turn to join the one-on-one session. In one nonlimiting example, the method includes dynamically terminating the temporary virtual conference room and moving the second user to the one-on-one session once the first user has left.

In one nonlimiting example, the method further includes notifying the host that the second user has been placed in the temporary virtual conference room. The notifying includes an electronic message being sent to the host or a chat message being displayed to the host. In one nonlimiting example, modifying allotted time interval for a third user in a queue based on when the temporary virtual conference room for the second user is terminated, wherein the third user is scheduled subsequent to the second user, and notifying the third user of the modification to the allotted time interval for the third user in the queue.

It is appreciated that the attributes of a conversation between the host and the first user are derived by performing natural language processing (NLP) of content exchanged in the virtual conference room between the first user and the host. In one nonlimiting example, the temporary waiting room is created dynamically based on the joining time of the second user. In one nonlimiting example, the method may further comprise assigning queued users to a separate temporary waiting room. In one nonlimiting example, the method may further comprise notifying the queued users of their position in the queue.

In some embodiments, the method may include performing natural language processing (NLP) of content exchanged in the virtual conference room between the first user and a moderator. The second allotted time interval may be adjusted based on the NLP of the content exchanged in the virtual conference room between the first user and the moderator. The method may further include processing content exchanged between the second user and the moderator prior to the second allotted time interval where the adjusting the second allotted time interval is further based on the processing of the content exchanged between the second user and the moderator.

These and other features and aspects of the concepts described herein may be better understood with reference to the following drawings, description, and appended claims.

### BRIEF DESCRIPTION OF DRAWINGS

FIG. 1 is a diagram showing an example of users connecting to an online collaborative platform to conduct a virtual meeting according to some embodiments.

FIGS. 2A-2E shows an example of managing users joining a virtual meeting according to some embodiments.

FIGS. 3A-3C shows examples of notifications to participants of the virtual meeting of a change in allotted time interval in accordance with some embodiments.

FIG. 4 shows an example of a system configured to predict an ending time of an allotted time interval for a given participant and adjusting subsequent participants accordingly.

FIG. 5 is a relational node diagram depicting a neural network, in an example embodiment.

FIG. 6 is a flowchart for managing a virtual conference room associated with a virtual meeting in accordance with some embodiments.

FIG. 7 is a diagram of a processing server, in an example embodiment.

### DETAILED DESCRIPTION

The example embodiments described herein are directed to online technology such as collaborative platforms, webinar, and/or online presentation platforms for presenting content to an audience. The collaborative platform may include a communication system configured to facilitate communication between online users. Communication may be through an online forum, e.g., online group, online team, webinar, chat team, etc. The communication system may also facilitate communication between users via telephony and/or video conferencing, etc.

The communication system such as online collaborative system provides an environment that is configured to facilitate data/content exchanges, e.g., audio data, video data, content data (e.g., PowerPoint®, Word®, PDF, etc.), messaging (e.g., instant messaging), etc., amongst users. It is appreciated that the term “user(s)” generally refers to participants in a communication session whether as moderator or invitee(s) or team member(s). It is also appreciated that the term “user” is used interchangeably with “member” or “participant” or “audience” throughout the application. The term “host” or “moderator” refers to a participant in a communication session that is leading the meetings, and is understood to remain in the virtual environment for a series of meetings with invitees.

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of de-scribing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, al-though not necessarily, these quantities take the form of electrical, optical, or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “placing,” “generating,” “creating,” “fetching,” “trans-mitting,” “facilitating,” “providing,” “forming,” “detecting,” “processing,” “updating,” “instantiating,” “identifying,” “rendering,” “utilizing,” “launching,” “calling,” “starting,” “accessing,” “sending,” “conferencing,” “triggering,” “ending,” “suspending,” “terminating,” “monitoring,” “displaying,” “removing,” “performing,” “preventing,” “hiding,” “blocking,” “tracking,” “associating,” “queuing,” “controlling,” “inserting,” “detecting,” “modifying,” “replacing,” “applying,” “rendering,” merging,” “notifying,” “predicting,” “adjusting,” or the like, refer to actions and processes of a computer system or similar electronic computing device or processor. The computer system or similar electronic computing device manipulates and transforms data represented as physical (electronic) quantities within the computer system memories, registers or other such information storage, transmission, or display devices.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other trans-port mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

It is appreciated that the embodiments and examples are provided with respect to a videoconferencing application for illustrative purposes. However, the embodiments should not be construed as limited thereto. For example, a host or an administrator or any online user (e.g., presenter) may create an online group/team within an online collaborative environment with chat and/or audio functionality.

In a pre-Internet era environment for one-on-one meetings, instead of clicking a link, a participant physically walks into a meeting room at their scheduled meeting start time. If the prior participant's meeting is still ongoing past its scheduled end time, the door to the meeting room might be closed indicating to the participant not to enter. The subsequent participant may knock on the door to determine whether the prior meeting was still in session, and would wait for the prior participant to leave the room. Once that occurred, the subsequent participant would understand the prior meeting had ended, and then they could enter the room to begin their meeting.

The embodiments presented herein arise out of computer technology and are inextricably tied to online technology as well as computers facilitating virtual connections. In a post Internet era and with the advent of online technology to connect users virtually, a meeting may be created using an online collaborative platform to generate an online collaborative environment (e.g., a virtual conference room). A participant clicks a link to instantiate the online virtual meeting and to enter the online virtual meeting at a scheduled time. Traditionally, if the prior virtual meeting has not ended at the scheduled time (e.g., meeting has extended beyond its allotted time interval), the subsequent participant may interrupt that virtual meeting when they attempt to enter the virtual conference room at their scheduled meeting time. If a prior meeting has extended be-yond the allotted time interval, the subsequent participant has no indicator (e.g. the prior participant physically leaving the room) to suggest whether the prior meeting has ended or when it will end, so that the subsequent participant can enter the virtual conference room to begin their meeting.

The embodiments described herein arise out of the need to manage users and their respective schedule time to enter into a virtual meeting with minimal interruption to participants of a prior meeting. In other words, the embodiments described herein arise out of a problem that arises only in online technology and is therefore inextricably tied to computer technology. The embodiments described herein address the need to manage meeting participants of their respective times by automatically determining that a prior participant's meeting has extended beyond the allotted time interval when a subsequent participant clicks the link to enter the virtual conference room. The embodiments according to one nonlimiting example prevent the subsequent participant from entering the virtual conference room until the prior participant's meeting has ended. For example, if the prior online meeting has extended beyond its allotted time interval, then the subsequent participant is placed into a temporary virtual conference room when the subsequent participant instantiates the link associated with the online meeting, e.g., clicking on a link, to enter the virtual conference room. Once the prior online meeting ends, the virtual conference room where the participant is waiting is merged with the online virtual conference room where the host is already present. It is appreciated that in one nonlimiting example where the prior online meeting associated with a prior participant is extended beyond the allotted time interval (e.g., runs past the scheduled end time), the online collaborative platform may automatically adjust the start time of the online meeting for the subsequent participant, and for all the following participants. It is appreciated that in some examples, the online collaborative platform may send out a notification to the host, the subsequent participant, and/or each following participant, to inform them that the subsequent meeting's start time has been adjusted. According to some embodiments, the on-line collaborative platform is configured to allow the host to override the automatic adjustment to the subsequent meeting start times, if desired. In one nonlimiting example, natural language processing (NLP) or artificial intelligence (AI) may be leveraged to make a prediction with respect to whether the current online meeting will conclude within the allotted time interval or whether it will extend beyond the allotted time interval and if so it may determine the amount of time that it may extend beyond. In some embodiments, NLP or AI may process data exchanged throughout a given online meeting and/or data exchanged prior to the online meeting to determine whether the online meeting will conclude within the allotted time interval and if not it may predict the amount of time needed by the participants.

A host, moderator, or an administrator may desire to hold a series of one-on-one on-line meetings with individual participants using the online collaborative platform. For example, a user may create a series of appointments, scheduled at set intervals, with various participants, to be held on the online collaborative environment. As one example, the online meetings may be for business purposes, such as between a supervisor and each employee. As another example, the online meetings may be for educational purposes, between a teacher and his students or parents. As another example, the online meetings may be for purposes of “speed dating.” Once the host's schedule of online meetings has been created (online collaborative environment, e.g., Microsoft Teams® account, RingCentral® account, Slack® account, Zoom® account, etc., that may include various applications such as a chat application, video conferencing, audio application, etc.), the host will send out a link to each participant, with instructions to click the link and enter the on-line collaborative environment at their scheduled time.

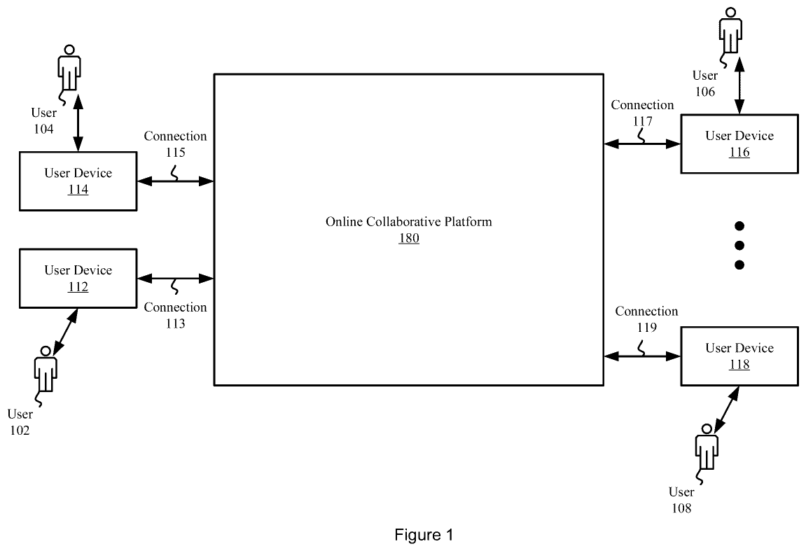

FIG. 1 is a diagram showing an example of users connecting to an online collaborative platform to conduct a virtual meeting according to some embodiments. In one nonlimiting example, an online collaborative platform 180 may be used by one or more online users to create an online meeting with one or more users. For example, the online collaborative platform 180 may be used by a user, e.g., user 104, via a user device 114 connecting to the online collaborative platform 180 via connection 115 to create a video conferencing meeting, an audio conferencing meeting, a textual conferencing meeting, etc. For illustration purposes that should not be construed as limiting the scope of the embodiments, a video conferencing session is described.

In one nonlimiting example, the user 104 may create an online virtual meeting for users 102, 106, and 108 at their designated time. For example, one online virtual meeting may be created, however, the allotted time interval for user 102 may be different from user 106 which may be different from user 108. In other words, each user may be allotted a certain time (e.g., unique start and end time). Once the online virtual meeting is created by the user 104 via user device 114 coupled via connection 115 to the online collaborative platform 180, the created online virtual meeting is transmitted to each respective participant. For example, the online virtual meeting for a first allotted time interval may be transmitted from the online collaborative platform 180 to the user device 112 associated with user 102 via connection 113. Similarly, the on-line virtual meeting for a second allotted time interval may be transmitted from the online collaborative platform 180 to the user device 116 associated with user 106 via connection 117. Moreover, the online virtual meeting for a third allotted time interval may be transmitted from the on-line collaborative platform 180 to the user device 118 associated with user 108 via connection 119.

In this example, the first allotted time interval (e.g., start time and end time) may be different from the second allotted time interval, which may be different from the third allotted time interval. For example, user 102 may be scheduled for 20 minutes starting at 2 p.m., while user 106 may be scheduled for 20 minutes starting at 2:20, and the user 108 may be scheduled for 30 minutes starting 2:40 or for 2:45 to provide a 5 minute break to the user 104 that is the host of the meeting. In some embodiments the users may be participants in parent-teacher meetings, speed dating, supervisor-employee meetings, etc.

It is appreciated that at the designated meeting time, each user 102-108, will use their own respective user device 112, 114, 116, 118, which may be a desktop computer, laptop computer, smartphone, tablet, smart watch, etc., to connect to the online collaborative platform 180 using connection 113, 115, 117, 119, which may be a WiFi, LAN, or other network connection, to instantiate their respective online virtual meeting. The online collaborative platform 180 then facilitates an online meeting between users 102-108 by rendering a graphical user interface (GUI) which contains various features and functionality available for the meeting, such as video, audio, chat functions, screen sharing, file sharing, etc. It is appreciated that the examples that follow describe a particular allotted time interval, duration, etc., for illustration purposes only and should not be construed as limiting the scope of the embodiments. For example, the duration meeting of different users may be different from one another, e.g., one user may be scheduled for 20 minutes while another scheduled for 10 minutes, etc. In yet one example, the duration of the meetings may be the same. It is appreciated that the meeting associated with the users may be scheduled subsequent to one another with a gap, e.g., a 5 minute break in between, or alternatively with no gap.

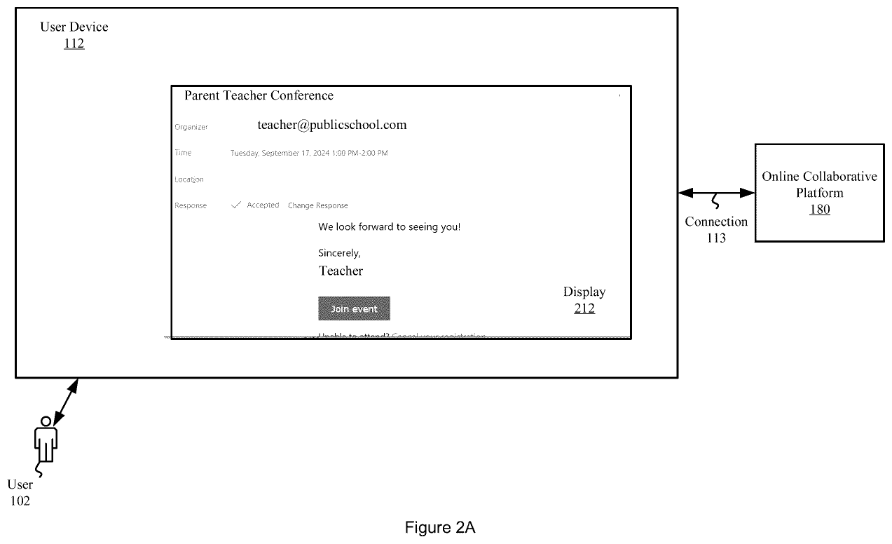

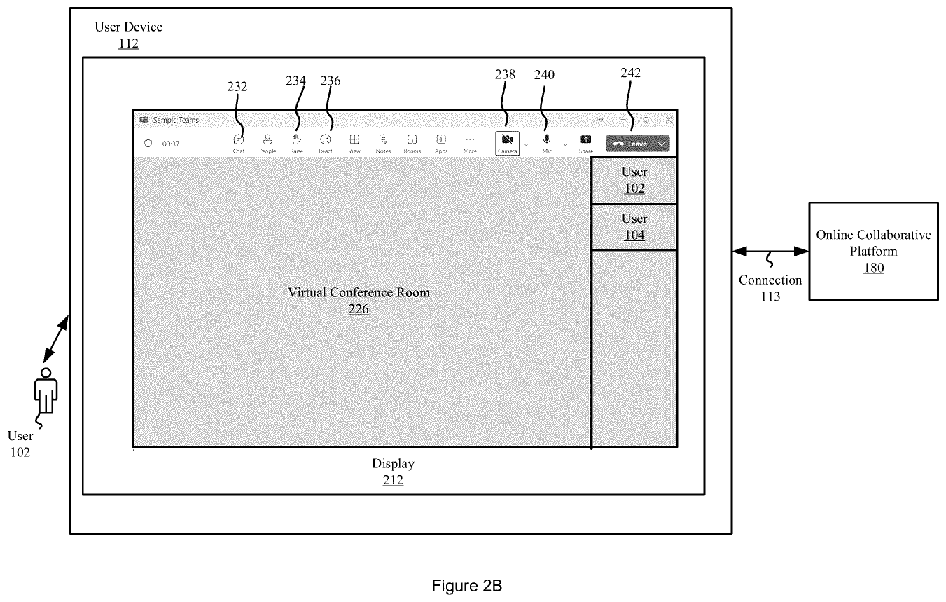

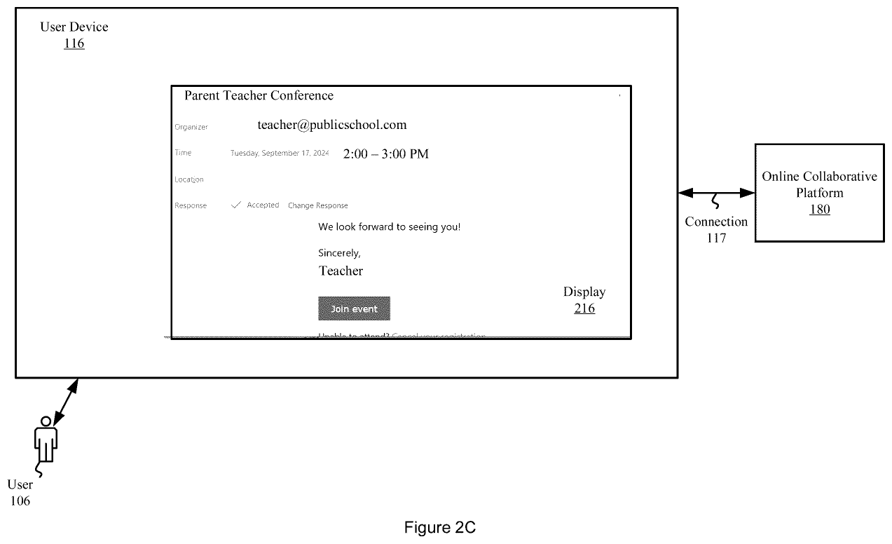

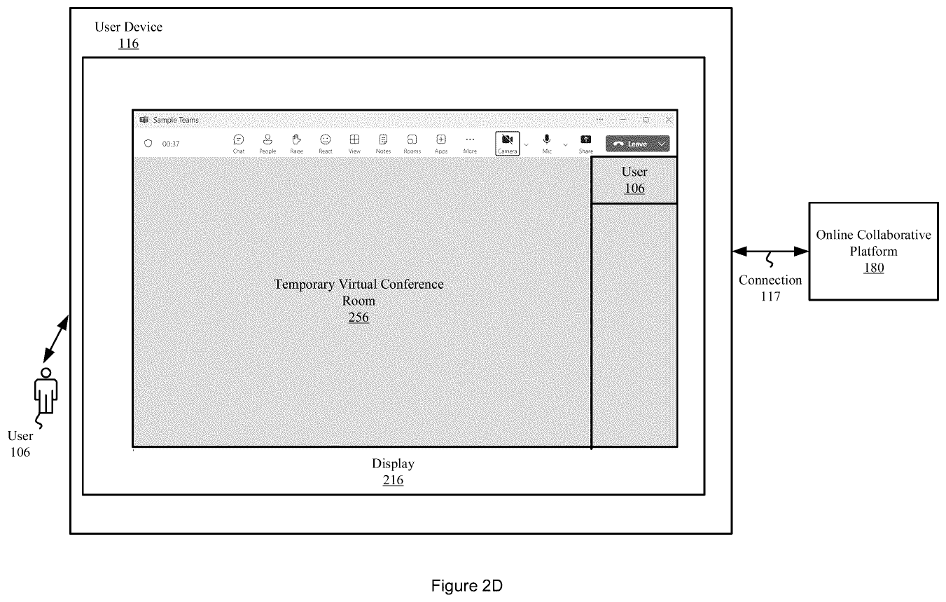

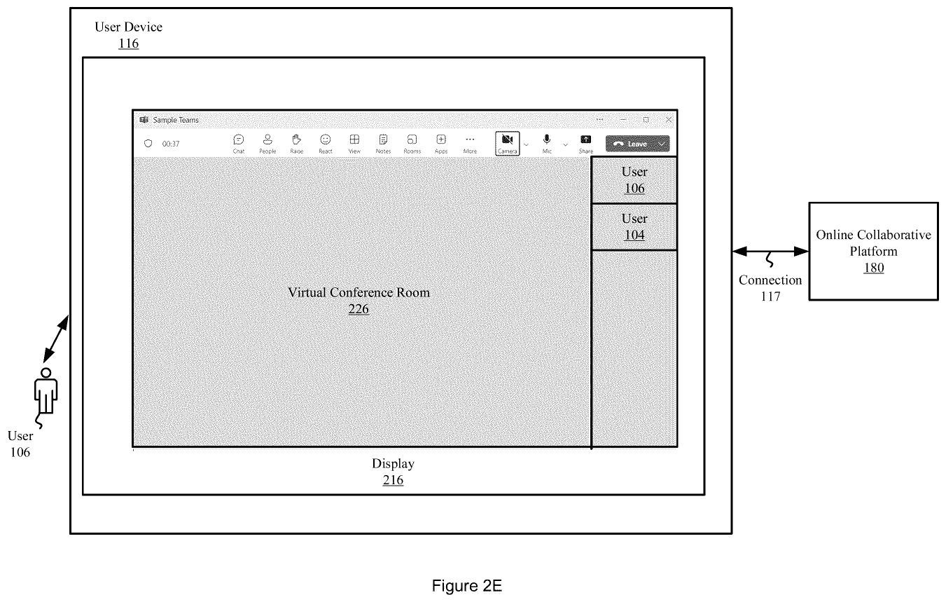

Referring now to FIGS. 2A-2E, an example of managing users joining a virtual meeting according to some embodiments is shown. In one nonlimiting example, the online virtual meeting has been created as described in FIG. 1. The online virtual meeting has been sent to the participants of the meeting. For example, as shown in FIG. 2A user 102, e.g., a student's parent, has received the online virtual meeting invite that is rendered on a display 212 of the user device 112, e.g., a laptop computer, a smartphone, etc. In this example, the notification is via email, with subject “Parent Teacher Conference,” for a one-on-one meeting between the user 102 and user 104, e.g., teacher host (moderator), scheduled for 1:00 p.m. to 2:00 p.m., sent by the user 104, here identified as “organizer” with the email address teacher@publicschool.com. The email contains a link titled “Join Event” for user 102 to click to join the online virtual meeting. As described in FIG. 1, the user device 112 has connection 113 to the online collaborative platform 180 to instantiate the online virtual meeting when the user 102 instantiates the “Join event” graphical icon by sending a signal to the online collaborative platform 180.

In one nonlimiting example, when user 102 clicks the link to initiate the meeting at 1:00 p.m., the signal that is sent to the online collaborative platform 180 causes the user 102 is merged into the virtual conference room 226 shown in FIG. 2B. It is appreciated that the user 104, e.g., host or teacher in this example, may use her own user device 114 to view a similar email notification, with a “Join Event” link. Like user 102, user 104 instantiates the link to join the online virtual meeting at the 1:00 p.m. start time designated in the email, by sending a signal using connection 115 to connect to the online collaborative platform 180.

As illustrated in FIG. 2B, a GUI of the virtual conference room 226 is rendered to user 102 on the display 212 of the user device 112, which is connected to the online collaborative platform 180 via connection 113. It is appreciated that in this nonlimiting example, the user 104 has also joined the virtual conference room 226, and might see a similar GUI of the virtual conference room 226 on her user device 114. Virtual conference room 226 may include a plurality of GUI icons to manipulate one or more functionalities associated with the online virtual meeting, e.g., chat 232, raising a hand to get attention 234, emoji reactions 236, camera on/off button 238, microphone on/off button 240, etc. It is appreciated that the features that are described are for illustrative purposes and should not be construed as limiting the scope of the embodiments.

Referring now to FIG. 2C, a subsequent meeting participant, e.g., user 106, who is a parent of another student, has a meeting scheduled for 2:00 p.m. to 3:00 p.m. is shown. User 106 views a notification on a display 216 of their user device 116 for joining the online virtual meeting. The notification may be presented in a calendar invitation, text message, etc. The email contains the subject “Parent Teacher Conference” for a one-on-one meeting between user 106 and user 104, is organized by the user 104, and contains a link titled “Join Event” for user 106 to instantiate. When user 106 instantiates the link to start their meeting, user device 116 sends a signal via connection 117 to the online collaborative platform 180 so that user 106 can join the virtual conference room 226 as shown in FIG. 2B.

However, in this nonlimiting example, user 106 clicks the “Join Event” link at 1:55 p.m., which is before 2:00 p.m., when their meeting is scheduled to start and is before the prior meeting is scheduled to end. In other words, the user 106 may instantiate the “Join Event” link during the time which is allotted to user 102 (from 1:00 p.m. to 2:00 p.m.) when user 102 meeting has yet to conclude. In some embodiments, when user 106 instantiates the online virtual meeting to join the virtual conference room 226 prior to the allotted time interval for user 106, the online collaborative platform 180 places the user 106 in a temporary virtual conference room 256, as shown in FIG. 2D. The temporary virtual conference room 256 may be rendered as a GUI on display 216 of the user device 116.

In another nonlimiting example, user 106 may click the “Join Event” link at 2:00 p.m. or after 2:00 p.m. (e.g., at or after the allotted time interval for user 106), but the online virtual meeting of user 102 may not have concluded during the allotted time interval for user 102 (e.g., user 102 has not departed for the ongoing meeting). In other words, the meeting for user 102 may have gone past the scheduled 2:00 p.m. end time. According to some embodiments, the user 106 may be placed in the temporary virtual conference room 256, until user 102 meeting ends (e.g., when user 102 departs from the online virtual meeting). Accordingly, interruption to online virtual meetings is minimized while protecting the privacy of the participants from unintended intrusion by others. When user 106 is placed in the temporary virtual conference room 256, user 104 may be sent a notification, via email, text message, chat message, pop up message, etc., indicating that the user 106 is placed in the temporary virtual conference room 256.

Referring now to FIG. 2E, the user 106 placed in the temporary virtual conference room 256 is moved to the virtual conference room 226 after conclusion of the meeting for user 102, e.g., at 2:02 p.m. It is appreciated that user 106 may not be moved to the virtual conference room 226 after the expiration of the allotted time interval for user 102 even if user 102 concludes the meeting prior to the end of the allotted time interval at 2:00 p.m. The online collaborative platform 180 displays the virtual conference room 226 as GUI on display 216 of the user device 116 after the temporary virtual conference room 256 is terminated. It is appreciated that the user 104 remains in the virtual conference room 226 after departure of user 102 to host the meeting with user 106. It is appreciated that the virtual conference room and the temporary virtual conference room are instantiated as part of the same meeting such that the same link can be instantiated by different users to join the meeting. However, the temporary virtual conference room creates an isolation between an ongoing meeting with participants and the next meeting scheduled at a different allotted time interval if the next user is early to the meeting or if the prior meeting has not concluded yet.

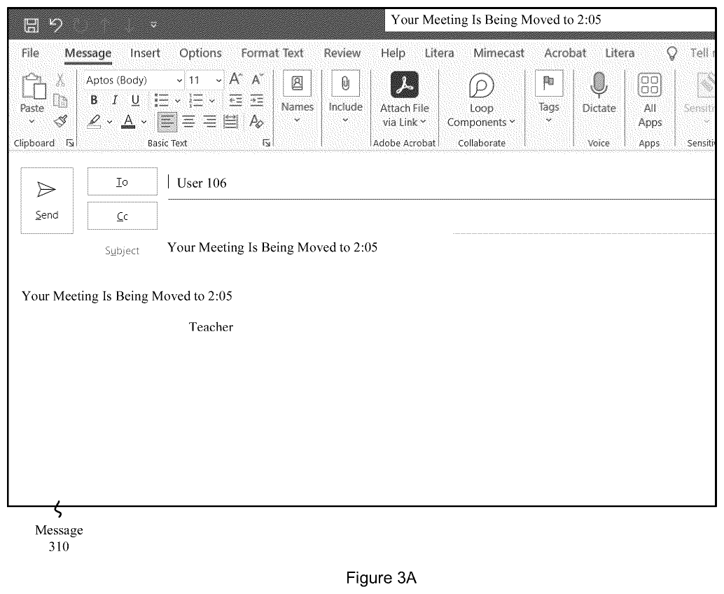

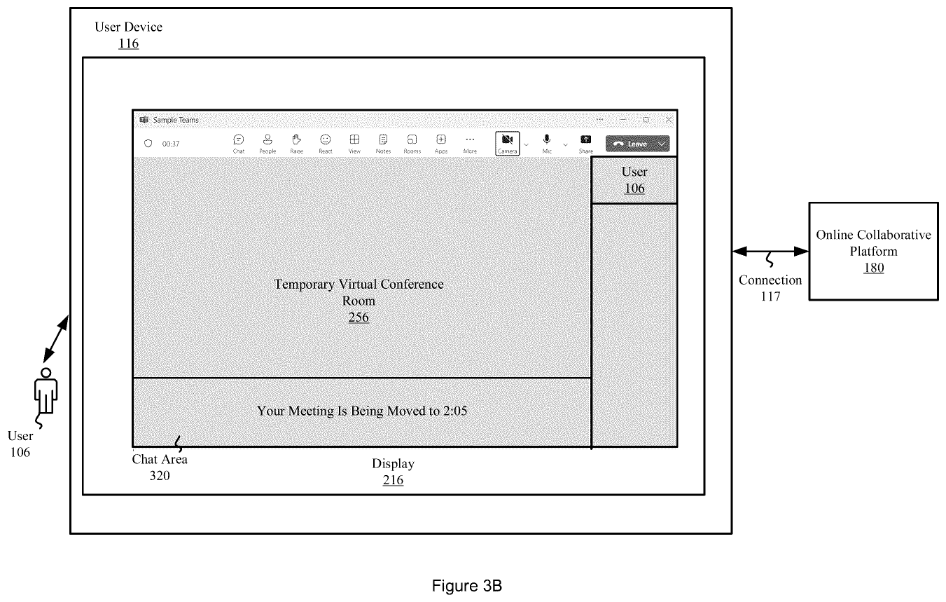

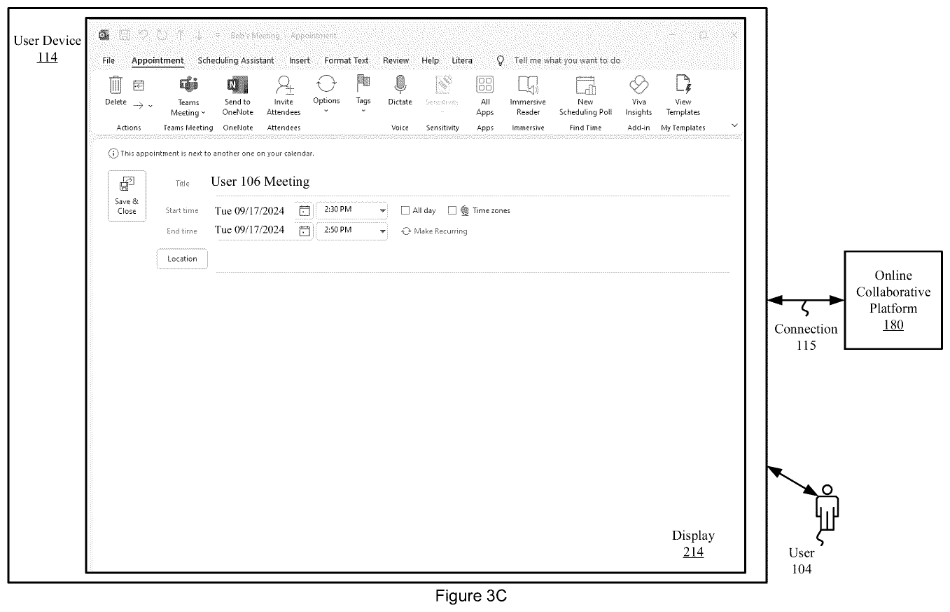

Referring now to FIGS. 3A-3C, examples of notifications to participants of the virtual meeting of a change in allotted time interval in accordance with some embodiments is shown. In FIG. 3A, a message 310 notification is sent to a subsequent participant that the prior meeting has run late. In one nonlimiting example, the message 310 may be an email that is sent to user 106, e.g., at 2 p.m., to notify user 106 that the allotted time interval has changed, e.g., the start of the meeting originally scheduled for 2:00 p.m., has been automatically modified by the online collaborative platform 180 to start at 2:05 p.m. A similar notification message may also be sent to user 104. In this nonlimiting example, a series of messages may be sent to each subsequent user, e.g., parents, modifying (adjusting) their allotted time interval, e.g., start time, to begin approximately 8% later due to extending the allotted time interval of the meeting for user 102. In an example, in the case of ten 20 minute meetings scheduled in a series, each participant's start time may be automatically rescheduled to start at approximately 8%, or here 5 minutes, later. A notice similar to the notification message 310 can be sent to each subsequent participant notifying them that their respectively scheduled meeting start times have been modified. It is appreciated that modifying the start time associated with an allotted time interval is provided for illustration purposes and should not be construed as limiting the scope of the embodiments. For example, the duration of an allotted time interval may also be adjusted, if desired. As one nonlimiting example, adjusting the allotted time interval for user 106, e.g., reducing the amount of time, may enable changes to be made to the start time of user 106 without impacting other users that are scheduled after user 106.

In FIG. 3B, a notification message may also be rendered to user 106 in the temporary virtual conference room 256, via chat message in the chat area 320. User 104 may also view the notification message in chat area 320. The notification message can also be in the form of a phone call, text message or other push notifications to user mobile devices, etc. As such, the particular type of notification provided herein is for illustrative purposes and should not be construed as limiting the scope of the embodiments.

In one nonlimiting example, user 104 may have the ability to control the meeting times by manually overwriting the modification provided by the online collaborative platform 180, as illustrated in FIG. 3C. For example, the user 104 may overwrite the allotted time interval of user 106 as automatic rescheduled by the online collaborative platform 180, e.g., overwriting the start time for the meeting for user 106. In one nonlimiting example, the user 104 may use a outlook calendar invitation rendered on the display 214 of the user device 114, to modify the allotted interval time of the user 106, e.g., to start at 2:30 p.m. instead of 2:05 p.m. as was originally modified by the online collaborative platform 180.

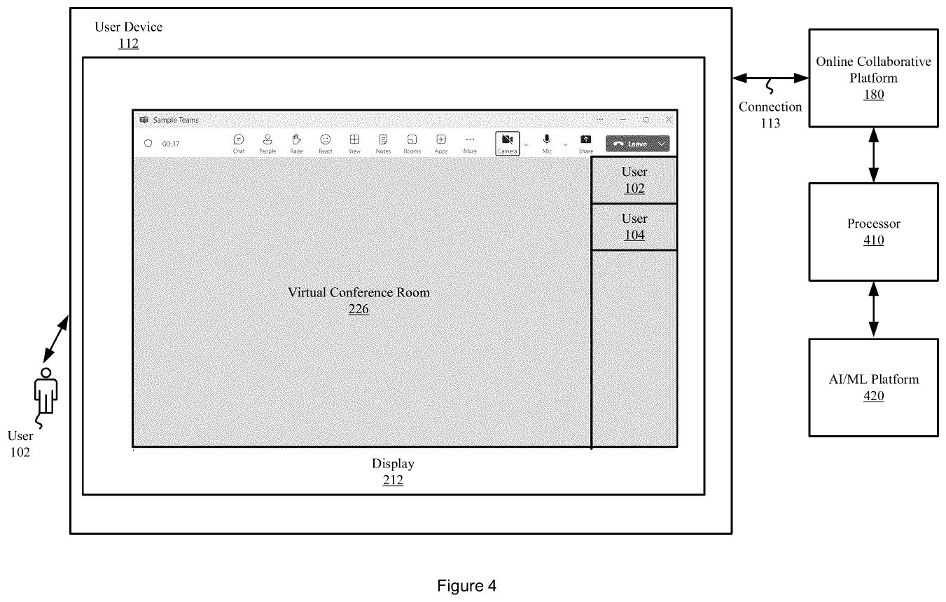

FIG. 4 shows an example of a system configured to predict an ending time of an allotted time interval for a given participant and adjusting subsequent participants accordingly. FIG. 4 is similar to the embodiments described in FIGS. 1-3C where the online collaborative platform 180 is communicatively coupled to a processor 410 and an AI/machine learning (ML) platform 420. The processor 410 may be one or more processing devices configured to perform functions of the disclosed methods, such as a microprocessor and may be a single core or multiple core processors executing parallel processes simultaneously and may include virtual processing (e.g., virtual machines). The processor 410 and/or AL/ML platform 420 may be used to predict an ending time for a meeting taking place in the virtual conference room. For example, the processor 410 and/or AL/ML platform 420 may be used to predict when the meeting for user 102 may be concluded at 2:05 that may be after the allotted time interval for user 102. Alternatively, the processor and/or AL/ML platform 420 may predict that the meeting for user 102 may be concluded prior to 2:00 p.m. that may be before the allotted time interval for user 102. As such, appropriate adjustment to subsequent allotted time intervals may be made by the online collaborative platform 180 based on the predicted end time of the meeting for user 102. In other words, start time associated with user 106 may be adjusted based on predicting that the meeting for user 102 may not conclude within the allotted time interval for user 102. It is appreciated that the prediction may occur prior to reaching the end of the allotted time interval for user 102. In other words, the online collaborative platform 180 leverages the processor 410 and/or AI/ML platform 420 to predict whether subsequent allotted time intervals for subsequent users should be modified based on whether a prior user, e.g., user 102, is able to conclude the meeting within the allotted time interval. In some embodiments the online collaborative platform 180 leveraging the processor 410 and/or AI/ML platform 420 may monitor data being exchanged between user 102 and user 104. In one embodiment, the AI/ML platform 420 uses AI to analyze different factors such as the communication between user 102 and user 104, or a meeting agenda or other material shared between user 102 and 104 prior to the meeting start, to determine if the meeting is predicted to extend past the scheduled end time when the meeting has been initiated. In other words, the prediction occurs during the pendency of the meeting between users 102 and 104 and appropriate modification to allotted time intervals of subsequent users, e.g., user 106, to occur in order to reduce inconvenience to all users. As an example, the AI/ML platform 420 may perform NLP to process communication exchanges between users 102 and 104 during the allotted time interval (e.g., 1:00 p.m. to 2:00 p.m.) to determine the progress of the meeting between users 102 and 104 (e.g., determining that 3 out of 5 identified items have been covered, or that 1 out of 4 items have been covered but that was the lengthiest to get through, etc.) and may access additional data, e.g., prior email exchanges, prior documents shared, meeting agenda, subject matter, etc., to make a prediction whether the meeting between users 102 and 104 is on track to conclude during the allotted time interval or whether it is going to extend beyond the allotted time interval. As the predicted end time might be sent via notification, together with notice of an automatically rescheduled subsequent meeting start time, to user 106 who is waiting in the temporary virtual conference room 256. In another example, the notification may be sent to the user 104 such that the user 104 has the opportunity to overwrite the automatic rescheduling of subsequent meetings and their respective allotted time intervals.

It is appreciated that different ML models may be used based on the type of data. For example, one ML model may be used for segmenting audio data whereas another ML model may be used for video data whereas, yet another ML model may be used to reconcile the determination made by ML models associated with audio portion and video portion of the data.

One or more of the modules discussed herein may use ML algorithms or models. In some embodiments, some of the modules of FIGS. 1-4 comprise one or more ML models or implement ML techniques. For instance, the module of FIG. 4 may be one or more of: Voice Activity Detection (VAD) models, Gaussian Mixture Models (GMM), Deep Neural Networks (DNN), Recurrent Neural Network (RNN), Time Delay Neural Networks (TDNN), Long Short-Term Memory (LSTM) networks, Agglomerative Hierarchical Clustering (AHC), Divisive Hierarchical Clustering (DHC), Hidden Markov Models (HMM), Natural Language Processing (NLP), Convolution Neural Networks (CNN), General Language Understanding Evaluation (GLUE), Word2Vec, Gated Recurrent Unit (GRU) networks, Hierarchical Attention Networks (HAN), or any other type of machine learning model. The models listed herein serve as examples and are not intended to be limiting.

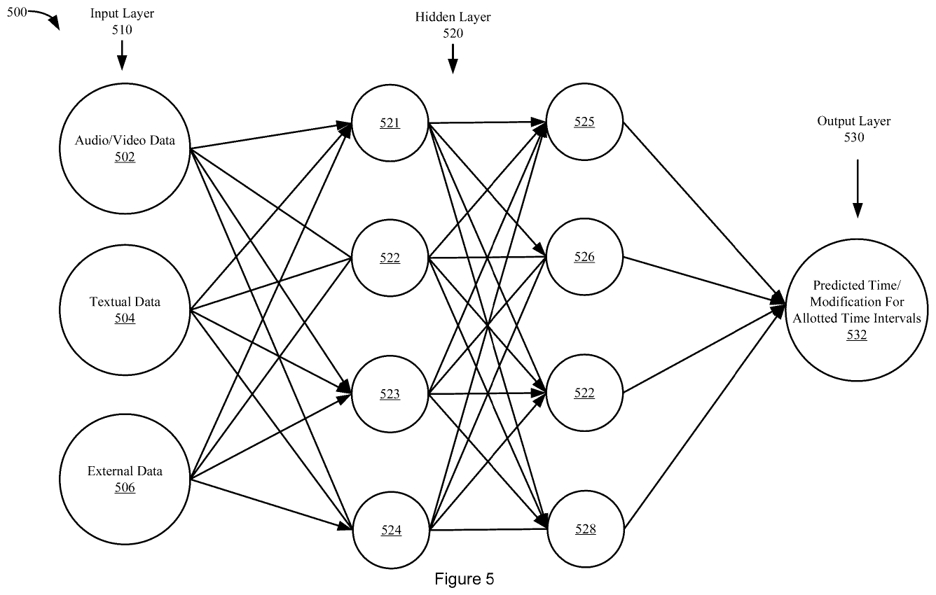

In the example of FIG. 5, the input layer 510 includes a plurality of training datasets that are stored as a plurality of training input matrices in an associated database. The training input data includes, for example, audio/video data 502, textual data 504 and external data 506. The audio/video data 502 may related to communication (audio/video) between users during online virtual meeting in the virtual conference room, e.g., between users 102 and 104 during the allotted time interval of 1:00 p.m. to 2:00 p.m. It is appreciated that this data may include voice of the users and/or video frames of the users. The textual data 504 may include Short Message Service (SMS) or Multimedia Messaging Service (MMS) messages, messaging applications messages, collaboration tool messages, e-mail messages, transcriptions, files being shared, etc., between users, e.g., users 102 and 104, during their allotted time interval in the virtual conference room. The external data 506 may include data communication exchanges between the users, e.g., phone calls, text messages, emails, etc. In other words, users 102 and 104 may have communicated before or outside of the allotted time interval that they may wish to discuss four topics and may further include certain information regarding those topics. While the example of FIG. 5 uses a single neural network for audio/video data 502, textual data 504, and external data 506, in some embodiments, separate neural networks may be used in association with any set of training data. Any number of neural networks may be used to train.

In the embodiment of FIG. 5, hidden layers 520 represent various computational nodes 521, 522, 523, 524, 525, 526, 527, 528. The lines between each node 521, 522, 523, 524, 525, 526, 527, 528 represent weighted relationships based on the weight matrix. As discussed above, the weight of each line is adjusted overtime as the model is trained. While the embodiment of FIG. 5 features two hidden layers 520, the number of hidden layers is not intended to be limiting. For example, one hidden layer, three hidden layers, ten hidden layers, or any other number of hidden layers may be used for a standard or deep neural network. The example of FIG. 5 also features an output layer 530 with the predicted time/modification for allotted time intervals 532, as described in FIG. 4 above, as the known output. The predicted time/modification for allotted time intervals 532 indicates the predicted time for which the current (ongoing meeting) is predicted to end and the modifications to subsequent allotted time intervals associated with subsequent users to be made. For example, the predicted time/modification for allotted time intervals 532 may be estimated for the end time to be 2:05 p.m. and that surpasses the allotted time interval by 5 minutes, and as such subsequent allotted time intervals are to be modified by 5 minutes, e.g., start time adjusted by 5 minutes each and/or duration of the allotted time interval modified. As discussed above, in this structured model, the predicted time/modification for allotted time intervals 532 is used as a target output for continuously adjusting the weighted relationships of the model. When the model successfully outputs the predicted time/modification for allotted time intervals 532, then the model has been trained and may be used to process live or field data.

Once the neural network 500 of FIG. 5 is trained, the trained AI/ML platform 420 and/or processor 410 will accept field data at the input layer 310, such as current communication, e.g., text, audio/video, file exchanged, screen shared, as well as external data, e.g., prior emails, telephone calls, messages, etc. In some embodiments, the field data is live data that is accumulated in real time, such as a live streaming video and/or audio of a conference session. In other embodiments, the field data may be current data that has been saved in an associated database. The trained AI/ML platform 420 may apply the field data to determine the predicted time that the meeting is going to conclude and whether to adjust the allotted time interval for subsequent users.

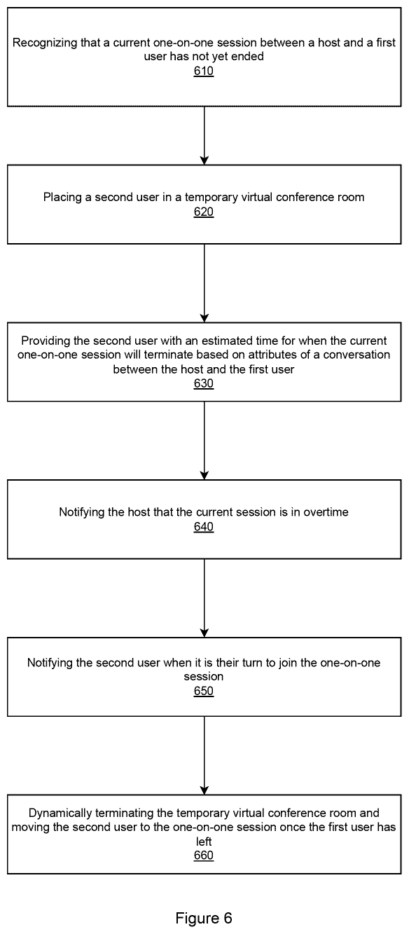

FIG. 6 shows a flowchart for managing a virtual conference room associated with a virtual meeting in accordance with some embodiments. At step 610, it is recognized if a current one-on-one session between a host and a first user has not yet ended, as described above with respect to FIGS. 1-4. At step 620, the first user is placed into the temporary virtual conference room, as described above. At step 630, the second user is provided with an estimated time for when the current one-on-one session will terminate based on attributes of a conversation between the host and the first user, as described above in FIGS. 1-4. At step 640, the host is notified that the current session is in overtime, as described in FIGS. 1-4. At step 650, the second user is notified when it is their turn to join the one-on-one session, as described above in FIGS. 1-4. At step 660, the temporary virtual conference room is dynamically terminated, and the second user is moved to the one-on-one session once the current user has left, as described above in FIGS. 1-4.

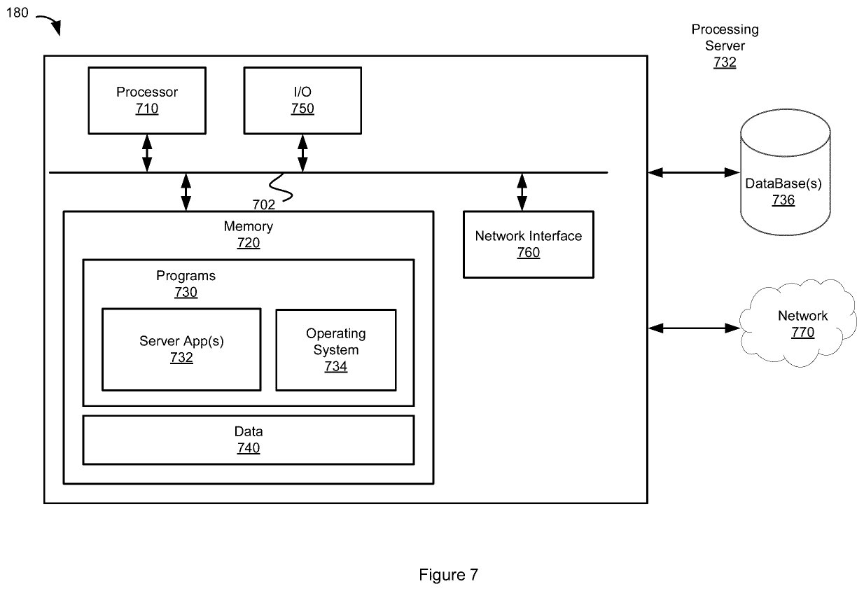

FIG. 7 shows a diagram of an example of online collaborative platform 180, consistent with the disclosed embodiments. The online collaborative platform 180 includes a bus 702 (or other communication mechanism) which interconnects subsystems or components for transferring information within the online collaborative platform 180. As shown, the online collaborative platform 180 includes one or more processors 710, input/output (“I/O”) devices 750, network interface 760 (e.g., a modem, Ethernet card, or any other interface configured to exchange data with the network 770), and one or more memories 720 storing programs 730 including, for example, server app(s) 732, operating system 734, and data 740, and can communicate with an external database 736 (which, for some embodiments, may be included within the online collaborative platform 180). The online collaborative platform 180 may be a single server or may be configured as a distributed computer system including multiple servers, server farms, clouds, or computers that interoperate to perform one or more of the processes and functionalities associated with the disclosed embodiments.

The processor 710 may be one or more processing devices configured to perform functions of the disclosed methods, such as a microprocessor manufactured by Intel™ or manufactured by AMD™. The processor 710 may comprise a single core or multiple core processors executing parallel processes simultaneously. For example, the processor 710 may be a single core processor configured with virtual processing technologies. In certain embodiments, the processor 710 may use logical processors to simultaneously execute and control multiple processes. The processor 710 may implement virtual machine technologies, or other technologies to provide the ability to execute, control, run, manipulate, store, etc. multiple software processes, applications, programs, etc. In some embodiments, the processor 710 may include a multiple-core processor arrangement (e.g., dual, quad core, etc.) configured to provide parallel processing functionalities to allow the online collaborative platform 180 to execute multiple processes simultaneously. It is appreciated that other types of processor arrangements could be implemented that provide for the capabilities disclosed herein.

The memory 720 may be a volatile or non-volatile, magnetic, semiconductor, tape, optical, removable, non-removable, or other type of storage device or tangible or non-transitory computer-readable medium that stores one or more program(s) 730 such as server apps 732 and operating system 734, and data 740. Common forms of non-transitory media include, for example, a flash drive a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The online collaborative platform 180 may include one or more storage devices configured to store information used by processor 710 (or other components) to perform certain functions related to the disclosed embodiments. For example, the online collaborative platform 180 may include memory 720 that includes instructions to enable the processor 710 to execute one or more applications, such as server apps 732, operating system 734, and any other type of application or software known to be available on computer systems. Alternatively or addition-ally, the instructions, application programs, etc. may be stored in an external database 736 (which can also be internal to the online collaborative platform 180) or external storage communicatively coupled with the online collaborative platform 180 (not shown), such as one or more database or memory accessible over the network 770.

The database 736 or other external storage may be a volatile or non-volatile, magnetic, semiconductor, tape, optical, removable, non-removable, or other type of storage device or tangible or non-transitory computer-readable medium. The memory 720 and database 736 may include one or more memory devices that store data and instructions used to perform one or more features of the disclosed embodiments. The memory 720 and database 736 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, the online collaborative platform 180 may be communicatively connected to one or more remote memory devices (e.g., remote databases (not shown)) through network 770 or a different network. The remote memory devices can be configured to store information that the online collaborative platform 180 can access and/or manage. By way of example, the remote memory devices could be document management systems, Microsoft SQL database, SharePoint databases, Oracle™ databases, Sybase™ databases, or other relational databases. Systems and methods consistent with disclosed embodiments, however, are not limited to separate databases or even to the use of a database.

The programs 730 include one or more software modules configured to cause processor 710 to perform one or more functions consistent with the disclosed embodiments. Moreover, the processor 710 may execute one or more programs located remotely from one or more components of the online collaborative platform 180. For example, the online collaborative platform 180 may access one or more remote programs that, when executed, perform functions related to disclosed embodiments.

In the presently described embodiment, server app(s) 732 causes the processor 710 to perform one or more functions of the disclosed methods. For example, the server app(s) 732 cause the processor 710 to receive conference information, such as conference participants, communications of the conference participants; determine, based on the received communications of the conference participants whether to place the next user in a temporary virtual conference room or in the virtual conference room, when to move the next user to the virtual conference room, and determine/predict when the current meeting will end and whether subsequent allotted time intervals for subsequent users should be modified. In some embodiments, other components of the online collaborative platform 180 may be configured to perform one or more functions of the disclosed methods.

In some embodiments, the program(s) 730 may include the operating system 734 performing operating system functions when executed by one or more processors such as the processor 710. By way of example, the operating system 734 may include Microsoft Windows™, Unix™, Linux™, Apple™ operating systems, Personal Digital Assistant (PDA) type operating systems, such as Apple iOS, Google Android, Blackberry OS, or other types of operating systems. Accordingly, disclosed embodiments may operate and function with computer systems running any type of operating system 734. The online collaborative platform 180 may also include software that, when executed by a processor, provides communications with the network 770 through the network interface 760 and/or a direct connection to one or more user devices 112-118.

In some embodiments, the data 740 may include, conference information received from user devices 112-118, prior communications to the scheduled meeting, etc.

The online collaborative platform 180 may also include one or more I/O devices 750 having one or more interfaces for receiving signals or input from devices and providing signals or output to one or more devices that allow data to be received and/or transmitted by the online collaborative platform 180. For example, the online collaborative platform 180 may include interface components for interfacing with one or more input devices, such as one or more key-boards, mouse devices, and the like, that enable the online collaborative platform 180 to receive input from an operator or administrator (not shown).

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A method for managing queued participants in a one-on-one virtual conference, the method comprising:
recognizing that a current one-on-one session between a host and a first user has not yet ended;
upon recognizing that the current one-on-one session between the host and the first user has not yet ended, placing a second user in a temporary virtual conference room;
providing the second user with an estimated time for when the current one-on-one session will terminate based on attributes of a conversation between the host and the first user;
notifying the host that the current session is in overtime;
notifying the second user when it is their turn to join the one-on-one session; and
dynamically terminating the temporary virtual conference room and moving the second user to the one-on-one session once the first user has left.

2. The computer-implemented method of claim 1, wherein the method further comprises notifying the host that the second user has been placed in the temporary virtual conference room, wherein the notifying includes an electronic message being sent to the host or a chat message being displayed to the host.

3. The computer-implemented method of claim 1, wherein the method further comprises:
modifying allotted time interval for a third user in a queue based on when the temporary virtual conference room for the second user is terminated, wherein the third user is scheduled subsequent to the second user; and
notifying the third user of the modification to the allotted time interval for the third user in the queue.

4. The computer-implemented method of claim 1, wherein the attributes of a conversation between the host and the first user are derived by performing natural language processing (NLP) of content exchanged in the virtual conference room between the first user and the host.

5. The computer-implemented method of claim 1, wherein the temporary waiting room is created dynamically based on the joining time of the second user.

6. The computer-implemented method of claim 1, wherein the method further comprises assigning queued users to a separate temporary waiting room.

7. The computer-implemented method of claim 6, wherein the method further comprises notifying the queued users of their position in the queue.

8. A system for managing a virtual conference room associated with a virtual meeting, comprising:
a processor; and
a memory, storing a set of instructions, that when executed by the processor, causes:
recognizing that a current one-on-one session between a host and a first user has not yet ended;
upon recognizing that the current one-on-one session between the host and the first user has not yet ended, placing a second user in a temporary virtual conference room;
providing the second user with an estimated time for when the current one-on-one session will terminate based on attributes of a conversation between the host and the first user;
notifying the host that the current session is in overtime;
notifying the second user when it is their turn to join the one-on-one session; and
dynamically terminating the temporary virtual conference room and moving the second user to the one-on-one session once the first user has left.

9. The system of claim 8, wherein the set of instructions when executed by the processor further causes notifying the host that the second user has been placed in the temporary virtual conference room, wherein the notifying includes an electronic message being sent to the host or a chat message being displayed to the host.

10. The system of claim 8, wherein the set of instructions, that when executed by the processor, causes:
modifying allotted time interval for a third user in a queue based on when the temporary virtual conference room for the second user is terminated, wherein the third user is scheduled subsequent to the second user; and
notifying the third user of the modification to the allotted time interval for the third user in the queue.

11. The system of claim 8, wherein the attributes of a conversation between the host and the first user are derived by performing natural language processing (NLP) of content exchanged in the virtual conference room between the first user and the host.

12. The system of claim 8, wherein the temporary waiting room is created dynamically based on the joining time of the second user.

13. The system of claim 8, wherein the set of instructions when executed by the processor further causes assigning queued users to a separate temporary waiting room.

14. The system of claim 13, wherein the set of instructions when executed by the processor further causes notifying the queued users of their position in the queue.

15. A non-transitory, computer-readable medium storing a set of instructions that, when executed by a processor, cause:
recognizing that a current one-on-one session between a host and a first user has not yet ended;
upon recognizing that the current one-on-one session between the host and the first user has not yet ended, placing a second user in a temporary virtual conference room;
providing the second user with an estimated time for when the current one-on-one session will terminate based on attributes of a conversation between the host and the first user;
notifying the host that the current session is in overtime;
notifying the second user when it is their turn to join the one-on-one session; and
dynamically terminating the temporary virtual conference room and moving the second user to the one-on-one session once the first user has left.

16. The non-transitory, computer-readable medium of claim 15, storing a set of instructions that, when executed by a processor, causes: notifying the host that the second user has been placed in the temporary virtual conference room, wherein the notifying includes an electronic message being sent to the host or a chat message being displayed to the host.

17. The non-transitory, computer-readable medium of claim 15, wherein the set of instructions that, when executed by a processor, cause:
modifying allotted time interval for a third user in a queue based on when the temporary virtual conference room for the second user is terminated, wherein the third user is scheduled subsequent to the second user; and
notifying the third user of the modification to the allotted time interval for the third user in the queue.

18. The non-transitory, computer-readable medium of claim 15, wherein the attributes of a conversation between the host and the first user are derived by performing natural language processing (NLP) of content exchanged in the virtual conference room between the first user and the host.

19. The non-transitory, computer-readable medium of claim 15, wherein the set of instructions when executed by the processor further causes assigning queued users to a separate temporary waiting room.

20. The non-transitory, computer-readable medium of claim 19, wherein the set of instructions when executed by the processor further causes notifying the queued users of their position in the queue.
